(19) United States
(12) Patent Application Publication
(10) Pub. No.: US 2011/0010015 A1
(43) Pub. Date: Jan. 13, 2011

(54) METHOD FOR THE NOISE-REDUCING CONTROL OF A HEATING, VENTILATING AND/OR AIR CONDITIONING SYSTEM OF A MOTOR VEHICLE

(75) Inventors: Frank Jordan, Russelsheim (DE); Markus Matthes, Koln (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/832,897

(22) Filed: Jul. 8, 2010

(30) Foreign Application Priority Data
Jul. 10, 2009 (DE) 102009032600.6

(51) Int. Cl. G05D 19/02

(52) U.S. Cl. 700/280

(57) ABSTRACT

A method is provided for controlling a system (i.e., a heating, ventilating and/or air-conditioning of a motor vehicle. The control unit generates a control signal that regulates the system given a deviation of the actual value from a prescribed desired value by a threshold in order to reduce the deviation, wherein the threshold is varied as a function of a noise level prevailing inside the vehicle. In addition, a computer program product is provided for implementing such a method, as well as a correspondingly equipped air-conditioning system of a vehicle.

### CROSS-REFERENCE TO RELATED APPLICATION

This application claims priority to German Patent Application No. 102009032600.6, filed Jul. 10, 2009, which is incorporated herein by reference in its entirety.

### TECHNICAL FIELD

The present invention relates to a method for controlling a heating, ventilating and/or air conditioning system, in particular for controlling an HVAC-system of a motor vehicle. In addition, the invention encompasses a heating, ventilating or air-conditioning system suitable for implementing the method, as well as a computer program product for controlling it.

### BACKGROUND

Air-conditioning and ventilation systems as well as HVAC systems are increasingly becoming standard equipment in motor vehicles. These air conditioning systems are here controlled and actuated manually, for example by means of various adjustable ventilation levels, but also automatically, for example depending on a desired interior temperature set by the user.

Heating, ventilating and/or air conditioning systems, so-called HVAC systems, are usually equipped with an electronic control unit, for example that controls and adjusts the actuators allocated to the individual operational controls based on the setting of individual operational controls, for example ventilation, temperature or air flow switches and regulators, and/or as a function of preset operating parameters. For example, popular air conditioning systems have a heat exchange valve to regulate the blowout temperature, a fan to regulate the amount of air, and/or valves for setting the air outlet locations.

For example, known from DE 101 64 375 A1 is a controller for an air conditioning system with a control unit that receives input signals. This control unit is here designed to switch the air conditioning system into a lower noise mode upon receiving a predefined input signal, wherein parameters of relevance to safety are taken into account.

For example, it is here provided that, in the event of an input signal, such as for an incoming or outgoing telephone call or traffic messages, the fan setting of the air conditioner is reduced, thereby automatically reducing the sound intensity or volume emanating from the air conditioning system.

In addition to the ventilation fan and the acoustically perceptible airflow it can generate, a heating, ventilating and/or air conditioning system of a motor vehicle exhibits even more noise sources. For example, the individual, mechanical actuators of an air conditioning system that are often designed as flaps can generate a stop noise once an end position is reached.

It must additionally be noted that the mechanical or electromechanical actuators themselves, especially when designed as a positioning or stepping motor, can produce a noise that is perceptible and irritating to the vehicle passengers.

Providing the individual mechanical or electromechanical actuators of the air conditioning system with a separate noise attenuator is comparatively cost and labor-intensive both in terms of manufacture and assembly. In addition, such noise-attenuating measures would likely be accompanied by a loss in available construction area inside the motor vehicle.

Therefore, at least one object of the present invention is to provide a heating, ventilating and/or air-conditioning system as well as a method for its control, the activation of which via mechanical and/or electromechanical actuators is less perceptible to vehicle passengers. Embodiments of the invention are intended to make potentially disturbing actuating noises of a heating, ventilating and/or air-conditioning system of a motor vehicle less perceptible to the vehicle passengers, without having to make any constructional or structural changes to the air conditioning system.

### SUMMARY

The object underlying the invention is achieved by means of a method, a computer program product, a heating, ventilating or air-conditioning system, as well as a motor vehicle.

The method according to an embodiment of the invention is provided for controlling a heating, ventilating or air-conditioning system, in particular a so-called HVAC system (heating, ventilating, air-conditioning) of a motor vehicle, wherein the term air conditioning system in the context of the present specification to the invention is to be understood as any type of device suitable to influence the prevailing climate inside the motor vehicle. In particular, the term air-conditioning system as used here also refers to HVAC systems.

The air-conditioning system has a control unit that, especially in an automatic mode, generates a plant or system-regulating control signal designed to reduce the deviation of an actual value prevailing inside the vehicle from a prescribed desired value. To this end, the control unit performs comparisons at regular intervals between a set or prescribed desired value and the actual value prevailing inside the vehicle.

If the actual value deviates from the desired value by a prescribed threshold, the control unit generates a control signal, which causes the deviation between the desired and actual value to be reduced inside the air-conditioning system until it once again lies within the limits defined by the threshold. The embodiments of the invention further provide that this threshold be varied as a function of a noise level prevailing inside the vehicle.

It is here provided in particular that a control or regulation measure involving a deviation between the desired and actual value only be taken if the noise level inside the vehicle exceeds a prescribed threshold, so that any noises that arise during the control or regulation measure are barely perceptible by the vehicle passengers, if at all.

In the converse conclusion, this means that those control or regulation measures of the air-conditioning system to be provided for minimizing a deviation between the desired and actual value are blocked or time-delayed when only low noise level is present in the vehicle interior.

As a result of this measure, a regulation or control of the air-conditioning system or HAVC system associated with noise can be suspended in situations where the noise level prevailing inside the vehicle is relatively low until the interior noise level has reached a prescribed value, at which the corresponding control or regulation measure is acoustically barely perceptible any more, if at all.

In the event that the noise level remains for a prolonged period at a point where it suppresses the control and regulation of the air-conditioning system, modifying, in particular increasing, the threshold and permissible deviation between the desired and actual value is achieved by having the control or regulation measure for the air-conditioning system take place at a later time; specifically when the deviation between the actual value and desired value exceeds a correspondingly altered limit.

In this way, a controller is provided that optimizes with respect to both noise and air-conditioned comfort for a vehicle air-conditioning system.

An advantageous embodiment of the invention provides that the control signal be generated as a function of the noise level in a time-delayed fashion. This time delay can take place in combination with or as an alternative to the noise-dependent change in the threshold. For example, the time delay can be fixed or variable, in particular adjusted as a function of the respectively prevailing noise level.

Regardless of whether a noise-dependent threshold adjustment or a control or regulation measure takes place time-delayed relative to an automatically generated or manually actuated control signal, the embodiments of the invention are generally aimed at executing a control or regulation measure of a heating, ventilating or air-conditioning unit of a motor vehicle that is potentially associated with noises taking into account the air conditioned comfort only if the noise level already present inside the vehicle anyway masks or drowns out the noises of the air-conditioning system produced by a control or regulation measure.

Another preferred embodiment of the invention further provides that the shape, duration and/or amplitude of the control signal that can be generated by the control unit be varied as a function of the noise level. For example, if the noise level is particularly high, the control or regulation measure triggered by the control signal can indeed be accompanied by a comparatively high noise, such as an otherwise acoustically perceptible hitting of a vent flap.

However, if the noise level is relatively low, such as when the vehicle is stopped, the invention provides that the control signal can be changed in shape, duration and/or amplitude in such a way that the resultant regulation measure takes place at a lower level of noise, for example by having a heat exchange flap or vent flap or comparable mechanical actuator move more slowly.

The embodiments of the invention advantageously provide that the threshold for the deviation between the desired and actual value and/or the time value for the time-delayed execution of a control or regulation measure be lowered given an increasing noise level. In like manner, it can be conversely provided that this threshold and/or the time value are/is increased again as the noise level tapers.

Such a dynamic adjustment of threshold values to the noise levels prevailing inside the vehicle makes it possible to prevent the vehicle passengers from noticing potentially disruptive noises in existing heating, ventilating or air-conditioning systems without any significant structural intervention. It is also conceivable to retrofit already existing air-conditioning systems with such a control method.

The noise level-dependent actuator according to an embodiment of the invention for threshold and time value can be implemented in the form of individual, discrete modes, but also in the form of continuous functions. For example, in a discrete configuration, it can be provided that the noise level is divided into three different areas, for example quiet, medium and loud.

Depending on which area the currently prevailing noise level is in, the threshold and time value can then deviate by an invariably fixed measure from an initial value. For example, it can be provided for the threshold typically provided for temperature regulation that the threshold be raised from the desired and actual value to a level of, for example, 4 Kelvin. What this means is that, in an especially quiet environment, the system ensures that an automatic regulation and associated adjustment motion of mechanical actuators only takes place if the desired value deviates to over 4 Kelvin. At a medium noise level, it can be provided that the tolerable threshold is reduced to, e.g., 2 Kelvin. If the noise level lies in the loud area, a standard regulation and correspondingly proximate correction of the actual value relative to the desired value can take place.

It can additionally be provided that the control and regulation mechanism according to an embodiment of the invention prevent any control and regulation measure given a prevailing quiet noise level until such time as the actual value moves to within a 2 Kelvin limit from the desired value. For example, if the desired and actual value differ from each other within a range of 2 to 4 Kelvin, at least an intermittent, as minimally invasive a regulation of the air-conditioning system as possible must be provided at a low noise level. Finally, if the temperature deviation of the actual value from the desired value measures more than 4 Kelvin, it is provided that the actual temperature is directly controlled, regulated and corrected in order to maintain a tolerable air-conditioned comfort. The temperature deviations mentioned by way of explaining how the controller functions are only examples, and can assume any values that facilitate air-conditioned comfort or are tolerable for air-conditioned comfort.

In a further developed embodiment of the invention, the noise level is determined based on the engine speed, vehicle speed, wind speed, rain intensity, fan speed, air-conditioning system and/or volume setting of a radio or a vehicle infotainment system and/or estimated accordingly.

Parameters such as engine speed, vehicle speed and volume setting of the car radio, navigation system or car telephone are available in the of electrical system the vehicle anyway, and can be used by the control unit for determining, or at least roughly estimating, the noise level prevailing inside the vehicle by coupling the control unit via conventional vehicle information systems, such as a CAN bus or LIN bus.

In like manner, for example, the rain sensor can be used to estimate the rain intensity and associated precipitation-induced noise inside the vehicle. The wind speed typically correlates with the vehicle speed. Therefore, it is also available via the vehicle electrical system.

It is here advantageous that all of the parameters described above be available in the vehicle or its electronics system anyway, so that no structural measures other than a required coupling of the control unit to the vehicle electrical system need be taken to determine or estimate the interior noise level.

In addition, the invention can in like measure provide that the noise level inside the vehicle be measured by means of a sensor. For example, this makes it possible to also take into account the rolling noises generated by the vehicle and noticeable by the vehicle interiors, which can vary by tire and road surface.

It is here advantageous to measure the noise level inside the vehicle using a microphone already present in the vehicle, e.g., using the microphone of a vehicle telephone or a hands-free device arranged in the vehicle. In this way, the respective prevailing noise level can be determined in a comparatively precise manner, and used to control the air-conditioning system as a function of noise level.

Another embodiment of the invention further provides that the control signals be time-delayed or even suppressed as a function of the operating state of the system. Such a function proves advantageous in particular in cases where the air-conditioning system or the HVAC system is deactivated or inactive, since a control or regulation measure following the control signal would in this instance have a barely measurable effect anyway.

It is further advantageous in a preferred embodiment of the invention that the threshold and/or time value be set to a prescribed standard values by activating an actuator of the air-conditioning system, for example by the user activating control elements. In this way, the user can be provided with complete and direct control of the air-conditioning system or HVAC system. If the user activates a control element to implement an air conditioning change, it is to be given preference over a noise suppression action.

In another independent embodiment, a computer program product is provided, which has program means for controlling the control unit, which are designed for implementing the method described above for controlling and regulating a control unit of an air-conditioning system.

In addition, another independent aspect of the invention relates to a heating, ventilating or air-conditioning system for the inside of a motor vehicle, which has a control unit designed to generate a system-regulating control signal given a deviation of an actual value from a desired value by a prescribed threshold in order to reduce the deviation. It is here provided in particular that the threshold for the deviation between the desired and actual value can be varied as a function of a noise level prevailing inside the vehicle.

The control unit of the air-conditioning system is preferably coupled with the electrical system of the vehicle for determining and/or estimating the noise level. To this end, the control unit is linked in particular with a CAN bus or a LIN bus of the vehicle, so that parameters such as engine speed, vehicle speed, wind speed, rain intensity, fan speed, and volume setting of a vehicle infotainment system can be made available to the control unit of the air-conditioning system for determining or estimating the noise level inside the vehicle.

Another advantageous embodiment of the invention provides that the control unit or the signals that can be generated by it are provided and designed for activating mechanical and/or electromechanical actuators of the air-conditioning system, in particular for activating heat exchanger flaps and air guiding or deflecting flaps.

It is provided in particular that the heating, ventilating or air-conditioning system according to the invention exhibit a plurality of individual actuating devices, preferably ones that can be activated with an electric motor, wherein each actuator arranged inside the system so that it can pivot or slide can be provided with a driving device intended for this sole purpose, for example in the form of a stepping or positioning motor.

Another independent embodiment of the invention further relates to a motor vehicle equipped with a heating, ventilating or air-conditioning system according to embodiments of the invention, or with a corresponding HVAC system.

### BRIEF DESCRIPTION OF THE DRAWINGS

The present invention will hereinafter be described in conjunction with the following drawing figures, wherein like numerals denote like elements, and:

FIG. 1 is a diagrammatic block diagram of the heating, ventilating or air-conditioning system according to an embodiment of the invention; and

FIG. 2 is a diagrammatic, exemplary functional diagram of the regulation process according to an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

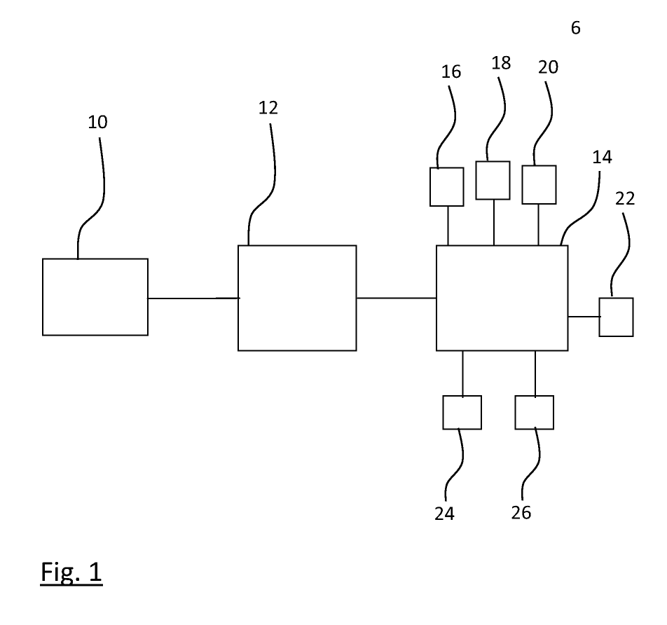

The heating, ventilating or air-conditioning system shown diagrammatically on FIG. 1, abbreviated with HVAC system 12, is controlled and regulated by a control unit 14. The HVAC system 12 is here connected with the vehicle interior 10 in such a way as to exchange air. The control unit 14 depicted as a separate unit next to the HVAC system 12 in the block diagram on FIG. 1 can also be designed in like manner as an integral component of an HVAC system 12.

For example, the control unit 14 is coupled with two control elements 24, 26, wherein the control element 24 is designed, for example, as a fan switch or air distribution switch or corresponding regulator or slide, while the control element 26 can be designed as a temperature switch or regulator.

In addition, the control unit 14 is coupled with a plurality of transducers or sensors 16 18, 20, 22. This coupling can take place directly and immediately with the control unit 14, or indirectly by way of a CAN or LIN bus of the vehicle electrical system.

For example, the sensor 16 can be a microphone designed as a noise sensor can provide direct information about the noise level prevailing in the vehicle at any one time. In addition, the volume of a radio 18 or the corresponding infotainment system can be used to derive a corresponding interior noise level. The engine speed as well as the vehicle speed can be fed in via corresponding sensors 20, 22 via the electrical system or, as an alternative, directly into the control unit 14.

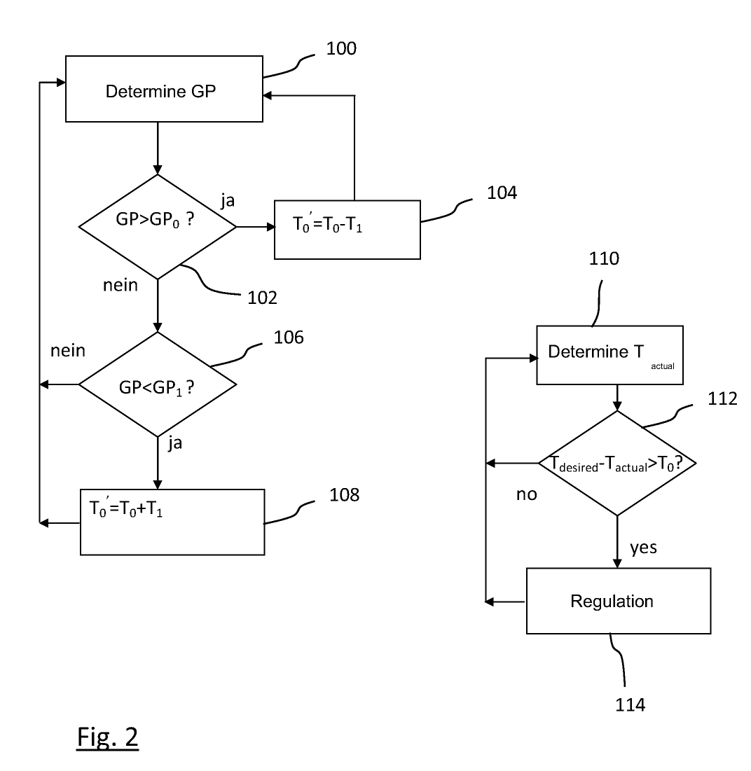

FIG. 2 presents a flowchart for a possible configuration of the control method according to the invention. Steps 110, 112, and 114 are examples of controlling or regulating temperature for the inside of the vehicle. In step 110, the interior temperature in the motor vehicle Tactual is measured by means of a suitable temperature sensor. This actual measured value Tactual is then compared with a prescribed desired temperature value Tdesired.

The resultant deviation is compared with a threshold T0 in an ensuing step 112. If the deviation is within or less than the set threshold T0, step 110 is performed again. This loop formed by steps 110, 112 is repeated until such time as a temperature deviation from the desired value Tdesired that exceeds the set threshold T0 is measured.

In this case, step 112 is followed by step 114, in which the control unit generates a control signal that regulates the air-conditioning system, so that the actual temperature approximates the desired temperature, reducing the deviation from the desired value to at least the measure prescribed by threshold T0.

In parallel with this temperature regulating mechanism implemented as a closed circuit involving steps 110, 112, and 114, a noise level-dependent change in the threshold T0 is provided. In step 100, the noise level GP prevailing inside the vehicle is measured, and then compared in a subsequent step 102 with the prescribed noise level threshold GP0.

If GP is greater than GP0, the threshold T0′=T0−T1 must be changed in an ensuing step 104. The temperature threshold T0 is consequently reduced by a prescribed value T1. In this scenario, the comparatively high noise level inside the vehicle lying at least above the threshold GP0 causes a relatively slight temperature deviation between Tactual and Tdesired.

However, if it is determined in step 102 that the measured noise level is less than the noise level threshold GP0, the measured noise level GP is compared in an ensuing step 106 with another noise level threshold GP1, wherein GP1 is less than GP0.

If the measured noise level GP is greater than GP1, step 106 is followed by step 100, in which the noise level is measured yet again. If the noise level GP lies between the two thresholds GP0 and GP1, no change will in the final analysis take place in the temperature threshold T0.

However, if the measured noise level GP in step 106 is less than the lower threshold GP1, the procedure in step 108 is altered by raising the temperature threshold T0′=T0+T1. In this case, a prevailing, relatively low noise level GP less than a lower noise level threshold GP1 causes a reduction in the threshold for the temperature deviation T0 by a prescribed value T1.

This makes it possible to achieve a situation where a temperature regulation of the air-conditioning system potentially associated with disruptive noises will only take place given a greater temperature deviation from the desired and actual value that would normally be the case.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for controlling a system of a motor vehicle, comprising the steps of:
receiving a given a deviation of an actual value from a prescribed desired value by a threshold;
generating a control signal with a control unit that regulates the system given the deviation of the actual value from the prescribed desired value by the threshold in order to reduce the deviation,
varying the threshold as a function of a noise level prevailing inside the motor vehicle.

2. The method of claim 1, further comprising the step of delaying the generating of the control signal by a time value as a function of the noise level.

3. The method of claim 1, wherein a characteristic of the control signal is varied as a function of the noise level.

4. The method of claim 3, wherein the characteristic is a shape of the control signal.

5. The method of claim 3, wherein the characteristic is a duration of the control signal.

6. The method of claim 3, wherein the characteristic is an amplitude of the control signal.

7. The method of claim 1, wherein the threshold decreases as the noise level rises.

8. The method of claim 1, wherein the noise level is determined based on a speed.

9. The method of claim 1, wherein the noise level is determined based on a setting of a vehicle infotainment system.

10. The method of claim 1, further comprising the step of measuring the noise level inside the motor vehicle with a sensor.

11. The method of claim 10, wherein the sensor is a microphone of a vehicle telephone.

12. The method of claim 1, wherein the generating of the control signal is adjusted depending on an operating state of the system.

13. The method of claim 1, further comprising the step of setting the threshold or time value to a prescribed standard value by activating an actuation device of the system.

14. A computer readable medium embodying a computer program product, said computer program product comprising:
a control program for controlling a system of a motor vehicle, the control program configured to:
receive a given a deviation of an actual value from a prescribed desired value by a threshold;
generate a control signal with a control unit that regulates the system given the deviation of the actual value from the prescribed desired value by the threshold in order to reduce the deviation; and
vary the threshold as a function of a noise level prevailing inside the motor vehicle.

15. The computer readable medium embodying the computer program product of claim 14, the control program further configured to delay the generating of the control signal by a time value as a function of the noise level.

16. The computer readable medium embodying the computer program product of claim 14, wherein a characteristic of the control signal is varied as a function of the noise level.

17. The computer readable medium embodying the computer program product of claim 16, wherein the characteristic is a shape of the control signal.

18. The computer readable medium embodying the computer program product of claim 16, wherein the characteristic is a duration of the control signal.

19. The computer readable medium embodying the computer program product of claim 16, wherein the characteristic is an amplitude of the control signal.

20. The computer readable medium embodying the computer program product of claim 14, wherein the threshold decreases as the noise level rises.

21. The computer readable medium embodying the computer program product of claim 14, wherein the noise level is determined based on a speed.

22. The computer readable medium embodying the computer program product of claim 14, wherein the noise level is determined based on a setting of a vehicle infotainment system.

23. The computer readable medium embodying the computer program product of claim 14, the control program further configured to measure the noise level inside the motor vehicle with a sensor.

24. The computer readable medium embodying the computer program product of claim 23, wherein the sensor is a microphone of a vehicle telephone.

25. The computer readable medium embodying the computer program product of claim 24, wherein the generating of the control signal is adjusted depending on an operating state of the system.

26. The computer readable medium embodying the computer program product of claim 14, the control program further configured to set the threshold or time value to a prescribed standard value by activating an actuation device of the system.

27. A system for an interior of a motor vehicle, comprising:
a sensor adapted to measure a noise level inside the motor vehicle;
a control unit adapted to generate a control signal that regulates the system given a deviation of an actual value from a desired value by a prescribed threshold in order to reduce the deviation,
wherein the prescribed threshold can be varied as a function of the noise level prevailing inside the motor vehicle.

28. The system of claim 27, wherein the control unit is coupled with an electrical system to determine and/or estimate the noise level.

29. The system of claim 27, wherein the control signal generated by the control unit is provided for activating a mechanical actuator.

30. The system of claim 27, wherein the control signal generated by the control unit is provided for activating an electromechanical actuator.
